(19) United States
(12) Patent Application Publication
(10) Pub. No.: US 2007/0235963 A1
(43) Pub. Date: Oct. 11, 2007

(54) Interchangeable and nestable storage bin and lid

(76) Inventors: Timothy D. Killinger, Plainfield, IL (US); Patrick Michael Flanagan, Chicago, IL (US); Justin O. Guthrie, Chicago, IL (US); Michael L. Pyle, Sugar Grove, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/391,524

(22) Filed: Mar. 28, 2006

(51) Int. Cl. B62B 1/00

(52) U.S. Cl. 280/47.26

(57) ABSTRACT

A storage container having a bin and a lid is provided. The bin has a base panel, a front panel and a rear panel extending upward from the base panel, and two side panels extending upward from the base panel and spanning between the front and rear panels. A storage space is defined by the volume above the base panel and between the side panel, the front panel and the rear panel. The side panel, front and rear panels flare outwardly, extend from the base panel, and define a storage space that is smaller in cross sectional area proximate the base panel than proximate upper ends of the side panel. The lid has a top panel with a perimeter and a lip extending downwardly from the perimeter, and the lip flares outwardly as it extends downwardly from the perimeter of the top panel to facilitate vertical nesting of a plurality of like lids. The lid is sized and shaped to cover the upper edges of the side panel, the front panel and the rear panel, the lip overlying and adjacent to a top portion of the side panel, the front panel and the rear panel when the lid is in a closed position on the bin.

### BACKGROUND OF THE DISCLOSURE

1. Field of the Disclosure

The disclosure is generally directed to storage containers, and more particularly to interchangeable and nestable storage bins and lids.

2. Related Technology

Storage devices have traditionally included generally cube-shaped, crate-type devices which may be used to store and/or transport file folders. These storage devices may be constructed of wood, plastic, metal, or other suitable material or combination of materials. Mostly, these storage devices are small enough to be carried by a single person with both hands and may include handles or holes on the sides for grasping. Occasionally, such devices may also include lids covering a top opening.

A significant drawback to these storage devices from a retail sales point of view occurs in bulk transportation and display of these storage devices for sale. Because such storage devices are typically made to hold a plurality of items, they may consist mostly of empty space, surrounded by four or more walls and a bottom. During bulk transportation from the manufacturer to the retailer, the volume of empty space within the storage device may be lost to the shipper and may result in a higher per unit cost to the retailer.

In an attempt to solve the problems mentioned above, storage devices have been designed which may nest with one another, thereby reducing the potentially empty volume during shipping. These designs, while at least partially successful in reducing lost transportation volume, are generally nested by inverting or rotating one storage device and inserting it partially into a like storage device. Therefore, the recovery of empty space is very limited in that only two such storage devices may be nested together.

### SUMMARY OF THE DISCLOSURE

A storage container having a bin and a lid is disclosed. The bin has a base panel, a front panel and a rear panel extending upward from the base panel, and two side panels extending upward from the base panel and spanning between the front and rear panels. A storage space is defined by the volume above the base panel and between the side panel, the front panel and the rear panel. The side panel, front and rear panels flare outwardly, extend from the base panel, and define a storage space that is smaller in cross sectional area proximate the base panel than proximate upper ends of the side panel. The lid has a top panel with a perimeter and a lip extending downwardly from the perimeter, and the lip flares outwardly as it extends downwardly from the perimeter of the top panel to facilitate vertical nesting of a plurality of like lids. The lid is sized and shaped to cover the upper edges of the side panel, the front panel and the rear panel, the lip overlying and adjacent to a top portion of the side panel, the front panel and the rear panel when the lid is in a closed position on the bin.

Further details of the storage container of the present disclosure may be appreciated with reference to the several views of the drawing, as well as the following detailed description of the preferred embodiments.

### BRIEF DESCRIPTION OF THE DRAWINGS

FIG. 1 is a perspective view of several interchangeable and nestable lids and bins;

FIG. 2 is an example of prior art storage devices stacked on a display shelf;

FIG. 3 is an example of the interchangeable and nestable lids and bins of FIG. 1, stacked on a display shelf;

FIG. 4 is a side cutaway view of the display shelf taken along line 4-4 of FIG. 3; and

FIG. 5 is a side view of a bin and three different lids, each of which is interchangeable with the bin;

### DETAILED DESCRIPTION OF THE PREFERRED EMBODIMENTS

The disclosure is generally directed to a system of storage containers. The disclosed storage container system includes a bin and a lid; the bin nests with other like bins in a stacked configuration that reduces the amount of retail display shelf space, shipping space, and storage space required for multiple bins. Likewise, the lid nests with other like lids in a stacked configuration that reduces the amount of retail display shelf space, shipping space, and storage space required for multiple lids. Additionally, the lids and bins are interchangeable with other lids and bins allowing a user to create a plurality of storage container configurations. Relative terms, such as front, back, vertical, horizontal, up, down, top, bottom, etc. are used only to describe elements as oriented in the drawings and are not meant to be limiting of the disclosure.

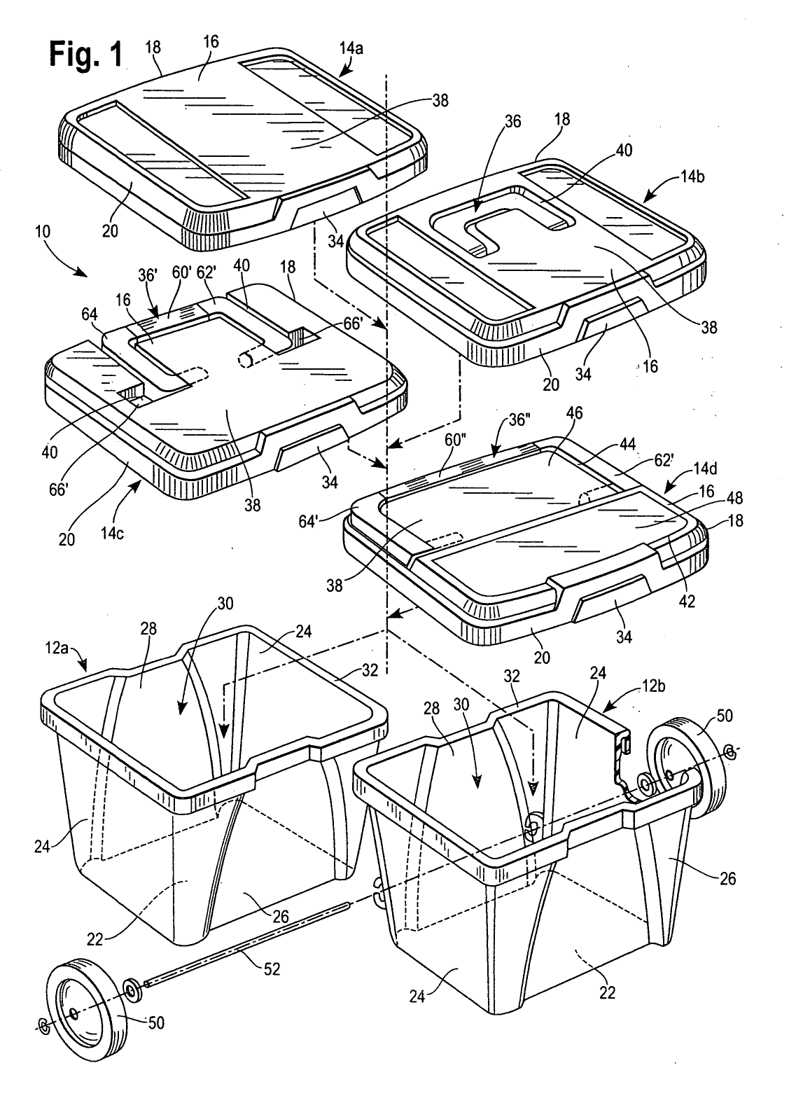

FIG. 1 is a perspective view of a storage container system 10 constructed in accordance with the teachings of this disclosure. The storage container system 10 includes at least one bin 12a, 12b and at least one lid 14a-d. The lid 14a-d may include a generally flat top panel 16 having a perimeter and a generally downwardly protruding lip 20 extending from the perimeter 18. The lip 20 may flare slightly outward, away from the perimeter 18 as the lip 20 extends downward. The lid 14a-d is vertically nestable with like lids 14a-d.

The bin 12a, 12b includes a generally flat base panel 22, two side panels 24 extending upward from the base panel 22, and front and rear panels 26, 28 extending generally upward from the base panel 22. The side panels 24 flare outwardly, away from one another. Likewise, the front and rear panels 26, 28 flare outwardly, away from one another. A storage space 30 is defined between the side, front and rear panels 24, 26, 28 and above the base panel 22. The bin 12a, 12b is vertically nestable with like bins 12a, 12b. Such nesting is facilitated by the shape of the bins 12a, 12b, wherein a lower perimeter of each bin 12a, 12b in a proximity to the base panel 22 is less than an upper perimeter of the bin in a proximity to an upper exposed edge of each of the front and rear panels 26, 28.

The lid 14a-d cooperates with top edges 32 of the side, front and rear panels 24, 26, 28 of the bin 12a, 12b to cover the storage space 30. The lid 14a-d may be hingedly attached to the top edge 32 of one of the side, front or rear panels 24, 26, 28 by a hinge (not shown). Opposite the hinge, the lid 14a-d may include a latch 34 for releasably securing the lid 14a-d in a closed position on the bin 12a, 12b. Further, the lid 14a-d may include a handle 36 disposed on a top surface 38 of the top panel 16. The handle 36 may be a single piece handle 36 or a multipiece handle 36′, 36″ (as described in more detail below), and the handle 36 may be hingedly connected to the lid 14a-d. Additionally, the top surface 38 may include a recessed portion 40 sized and shaped to cooperate with the handle 36. Thus, the handle 36 may lie within the recessed portion 40 in a stowed position when not in use.

Alternatively, the lid 14a-d may cooperate with the bin 12a, 12b with a “snap on” arrangement removably securing the lid 14a-d in place over the storage space 30.

The lid 14a-d may also include one or more openings 42, 44 therein which allow access to the storage space 30. The openings 42, 44 may be covered by flaps 46, 48 which releasably secure the openings 42, 44.

The bins 12a, 12b may include one or more wheels 50 disposed on a lower portion thereof that facilitate transportation of the bins 12a, 12b. The wheels 50 may be connected via an axle 52 and the axle 52 may be attached to one of the panels 24, 26, 28. Alternatively, each wheel 50 may be connected to the bin 12a, 12b via a “snap fit” arrangement in which a rod (not shown) extends from one panel through an opening or recess in the wheel 50.

The handle 36′, 36″ includes a tubular handle member 60′, 60″ secured between a first C-shaped handle connection member 62′ and a second C-shaped handle connection member 64′. Each of the C-shaped handle connection members 62′, 64′ is hingedly connected to the lid 14c-d. As shown in FIG. 1, the C-shaped handle connection members 62′, 64′ are received by the recessed portions 40 in the lid and secure the tubular handle member 60′, 60″ therebetween forming handles 36′, 36″ of different sizes. Each of the recessed portions 40 may include a lateral extension 66′ to facilitate securement of the C-shaped handle connection members to the lid 14c-d. Additionally, the tubular handle member 60′, 60″ may be provided in various lengths, thus facilitating formation of handles 36′, 36″ of different sizes using the same C-shaped receiving members 62′, 64′.

Thus, the only structural difference between the handles 36′, 36″ is that the tubular handle members 60′, 60″ are of different lengths. All other components of the handles 36′, 36″ (i.e., the C-shaped receiving members 62′, 64′) are common to both handles 36′, 36″. This feature allows the handles 36′, 36″ to maximize common parts thus decreasing manufacturing costs. In other words, the tubular handle member 60′, 60″ may be selected from a group of a first tubular handle member 60′ having a relatively short length and a second tubular handle member 60″ having a relatively long length. Further, the tubular handle members 60′, 60″ are generally hollow and have a rectangular (such as square) cross-sectional shape. Of course, the tubular handle members 60′, 60″ may have a circular, ovoid, or some other polygonal cross-sectional shape, and need not be hollow, but can have a solid or partially solid interior, so long as the ends of tubular handle members 60′, 60″ are able to securely mate with complementary ends of each of the C-shaped receiving members 62′, 64′. One skilled in the art may choose the cross-sectional shape based on ergonomics or other consumer preferences and/or desires.

Each of a plurality of lids 14a-d having different features may be interchanged with the bin 12a, 12b. For example, one lid 14b-d having a handle 36 may be interchanged with a lid 14d having two openings 42, 44 and used on the same bin 12a,12b. Likewise, each of a plurality of bins having different volumes or features may be interchanged with a single lid 14a-d. This interchangeability produces more storage container 10 combinations using fewer parts. As shown in FIG. 1, any one of the lids 14a-d is mountable on either of the bins 12a, 12b. Thus, in this example, eight different lid/bin combinations are possible with only six different parts (i.e., two bins 12a, b and four lids 14a-d). Previously, a merchandiser would have had to stock one of each storage container 10 (i.e., eight different combinations of containers and lids). Interchangeability in this example has reduced by 25% the number of different parts required.

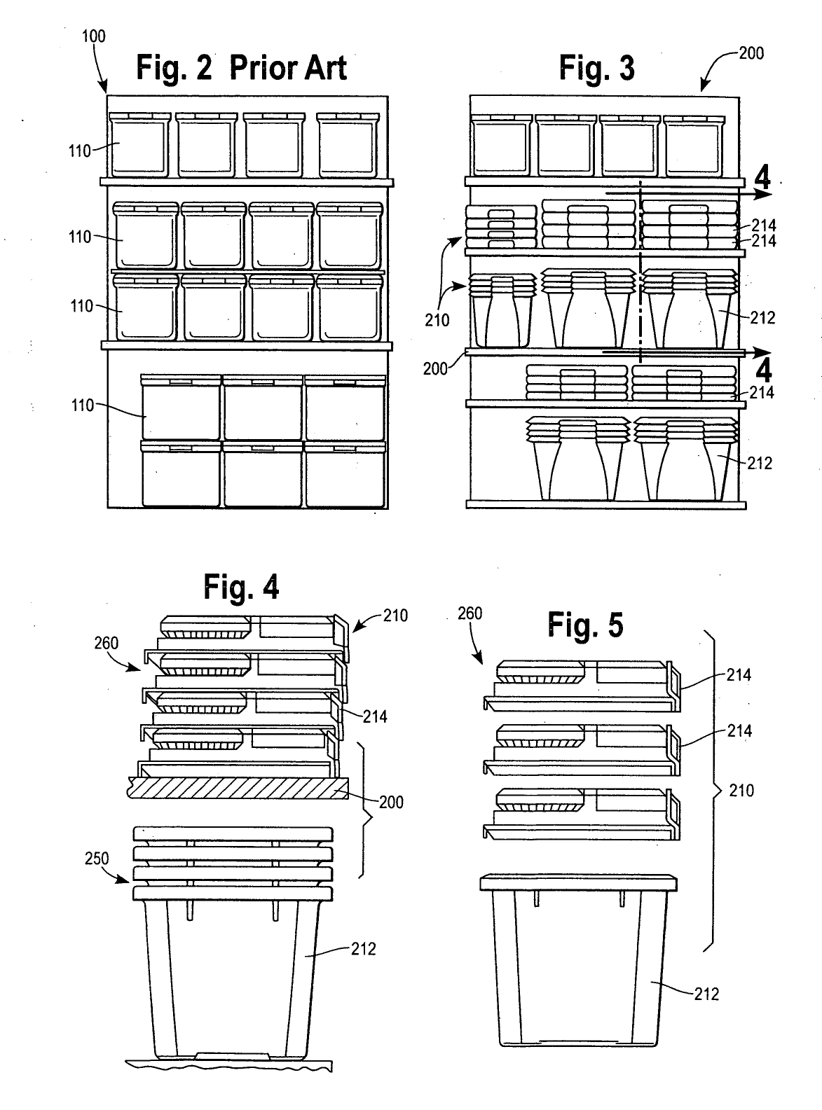

FIG. 2 is an example of a display shelf 100 holding prior art storage devices 110 for sale. Each storage device 110 is either stacked on top of another like storage device 110 or placed next to another like storage device 110. Because storage devices 110, by nature, contain mostly empty space, these prior art storage devices 110 are not efficiently displayed and/or shipped.

FIG. 3 is an example of a display shelf 200 holding storage containers 210 constructed in accordance with the teachings of this disclosure. Obviously, the storage containers 210 provided are more efficiently stacked for display. By nesting and stacking the lids 214 and bins 212, the storage containers 210 occupy less display space. Accordingly, a merchandiser may display more product on display shelves and thus store less product in the storage room. Another benefit of the nestable and stackable storage containers 210 is that fewer man-hours are required restocking the display shelves. Thus, a merchandiser uses available display space more efficiently, and decreases the labor required stocking the storage containers 210, thereby reducing shipping and/or storage costs.

FIG. 4 is a cross sectional view of the display shelf of FIG. 3 taken along line 4-4. A plurality of bins 250 is nested and stacked on a lower shelf and a plurality of lids 260 is nested and stacked on an upper shelf. Because the plurality of bins 250 and the plurality of lids 260 are nested and stacked vertically, the plurality of bins 250 and the plurality of lids 260 occupy the same horizontal “footprint” as a single bin 212 or lid 214. Thus, only a slight increase in vertical storage area results in large increase of stored items. This arrangement usually yields an increase of storage quantity of one to several orders of magnitude above conventional storage devices. Additionally, because the bins 212 and lids 214 are interchangeable, pluralities of different bins 250 and lids 260, all of which are interchangeable, may be stored proximate each other such that a consumer may simply choose a desired combination from any of the bins 212 and lids 214 to produce a desired storage container 210. The consumer is thus afforded a customizable storage container 210 with no extra merchandise or stocking required by the merchandiser.

FIG. 5 shows a single storage container 210 with a plurality of lids 260, any one of which may be used with the bin 212. Each of the lids 214 may include different features. For example, one lid 214 may be a simple essentially flat top; another may include a handle; and yet another may include one or more auxiliary openings therein for access to the storage space without opening the lid 214. Thus a consumer may create more than one type of storage container 210 by simply choosing a different lid 214. Likewise, while not shown, different bins 212 may be used with the same lid 214.

The interchangeable bins 212 and lids 214 thus provide a multiplicative effect. For example, by providing three different lids 214 and three different bins 212, essentially nine different storage containers 210 can be created. Conversely, known storage devices, because they are generally produced individually, require nine different complete devices to give the consumer the same nine options. Thus, the interchangeable and nestable storage bins 212 and lids 214 increase storage and shipping efficiency, while providing consumers with more and customizable storage container 210 options.

While the disclosed embodiments are generally manufactured from molded plastic, the storage container can, of course, be constructed from virtually any material. For example, the storage container may be constructed from polystyrene, polypropylene, polycarbonate, engineering grade plastic, ABS, TPE, thermoplastics, metal, wood, organic materials, leather, glass and/or combinations thereof.

The disclosed storage container improves upon maximizing retail shelf space, accommodates variable shelf space and configurations, and enhances product nesting for shipping, stock storage, and display for sale. Product nesting is accomplished by stacking each bin vertically upward relative to its preceding bin in a stack. Likewise, each lid is stacked vertically upward relative to its preceding lid in a stack. The stacked bins and lids are displayed and shipped without damage to the product due to scuffing, scratching, and the like because the products are tightly nested. Additional packing between adjacent bins and lids can be negated.

Additionally, freight cube size can be optimized and significantly reduced utilizing the disclosed nested bin and lid configuration. Products shipped in bulk can be directly unloaded from the master carton or shipping box onto a shelf. No additional reorientation of the product may be necessary, making the merchandiser's handling of the product easier. The nested bins and lids also assist in retaining the displayed bins and lids on a retail shelf space. The bins and lids also look more organized when nested as disclosed herein. This reduces the amount of work required by both customers and merchandisers to keep the shelf displays organized and arranged. An organized shelf space may effect the perception of the consumer and influence his or her decision to buy the displayed products.

Moreover, because the lids and bins are interchangeable, the consumer is presented with more options and the merchandiser may stock less items. For example, one size lid that may be used with three different sized bins may present at least three different sized storage containers. Additionally, stocking three different lids and three different bins presents at least nine different configurations of storage containers. Thus, in this example, approximately a 33% savings in types of storage containers is realized without reducing customer options. One skilled in the art will realize that the possible storage container configurations are directly proportional to the number of types of bins and lids provided.

Further, because more product can be displayed for sale in a given amount of shelf space, less restocking time and stocking space is necessary for the retailer. Having more product available and on display for sale at any one time reduces the frequency of an item appearing to be out of stock, which can prevent a consumer from leaving the establishment to go elsewhere to find the desired product.

Although certain storage containers that are nestable have been described herein in accordance with the teachings of the present disclosure, the scope of the appended claims is not limited thereto. On the contrary, the claims cover all embodiments of the teachings of this disclosure that fairly fall within the scope of permissible equivalents.

What is claimed is:

1. A storage container system comprising:
a bin including a base panel, a front panel and a rear panel extending upward from the base panel, and two side panels extending upward from the base panel and spanning between the front panel and the rear panel, a storage volume being defined above the base panel and between the side panels, the front panel and the rear panel; and
a lid having a top panel with a perimeter and a lip extending downwardly from the perimeter;
wherein the side panels, front and rear panel flare outwardly from the base panel and define a storage space that is smaller in cross sectional area proximate the base panel than near distal ends of the side panels, the front panel and the rear panel,
wherein the lip flares outwardly as it extends from the perimeter of the top panel; and
wherein the lid is sized and shaped to be received on the lip and cover upper edges of the side panels, the front panel and the rear panel, the lip overlying and adjacent to a top portion of the side panels, the front panel and the rear panel when the lid is in a closed position on the bin.

2. The storage container system of claim 1, including a plurality of additional lids, each lid having a different configuration and each of the plurality of lids being interchangeable and adapted to be received on the lip and cover the upper edges of the side panels, the front panel and the rear panel in a closed position.

3. The storage container system of claim 1, including a plurality of bins, each of the plurality of bins having different storage volumes, each of the plurality of bins adapted to receive the lid proximate upper ends of the side panels, the front panel and the rear panel.

4. The storage container system of claim 3, including a plurality of lids, each lid having a different configuration and each of the plurality of lids cooperating with any of the plurality of bins to close the storage space of any of the bins.

5. The storage container system of claim 1, wherein the storage bin is nestable with like storage bins.

6. The storage container system of claim 1, wherein the lid is nestable with like lids.

7. The storage system container of claim 1, wherein the lid includes at least two openings in the top panel, at least one of the openings exposing the storage space.

8. The storage system container of claim 1, wherein the lid includes a handle disposed on a top surface of the top panel.

9. The storage container system of claim 8, wherein the handle includes at least three structural members.

10. The storage container system of claim 9, wherein the handle includes a tubular handle member, a first C-shaped handle connection member, and a second C-shaped handle connection member, each of said first and second C-shaped handle connection members hingedly engaging the lid and said tubular member secured between the first and second C-shaped handle connection members.

11. The storage system container of claim 1, including at least one wheel attached to the bin.

12. The storage container system of claim 1, wherein the lid includes a latch for releasably securing the lid to the bin.

13. The storage container of claim 10, wherein the tubular handle member is selected from a group of a first tubular handle member having a relatively short length and a second tubular handle member having a relatively long length.

14. A storage container system comprising:
a bin including a base panel, a front panel and a rear panel extending upward from the base panel, and two side panels extending upward from the base panel and spanning between the front panel and the rear panel, a storage volume being defined above the base panel and between the side panels, the front panel and the rear panel; and
a lid adapted to be selectively securely received on an upper edge of the bin, said lid including a handle comprising a tubular handle member selected from a group of a tubular handle member of a relatively short length and a tubular handle member of a relatively long length, and a first handle connection member hingedly securable to the lid and adapted to engage the tubular handle member, and a second handle connection member hingedly securable to the lid and adapted to engage the tubular handle member.

15. The storage container system of claim 14, wherein the bin is nestable with like bins.

16. The storage container system of claim 14, wherein the lid is nestable with like lids.

17. The storage container system of claim 14, further including at least one wheel rotatably secured to the bin.

18. The storage container system of claim 13, wherein a lower perimeter of the bin in a proximity to the base is less than an upper perimeter of the bin in a proximity to an upper exposed edge of each of the front and rear panels.

19. An interchangeable and nestable storage system, comprising:
a plurality of bins, each of the bins being nestable in an upright orientation with bins of similar size and shape;
a plurality of lids, each of the lids being nestable in an upright orientation with lids of a similar size and shape, and being engageable with each of the plurality of bins,
and wherein at least one of the plurality of bins is adapted to rotatably receive at least one wheel.

20. The interchangeable and nestable storage system of claim 19, wherein at least one of the plurality of lids includes at least two openings in the top panel, at least one of the openings exposing a storage space within one of the plurality of bins when said one of the plurality of lids is engaged on said one of the plurality of bins.

21. The interchangeable and nestable storage system of claim 19, further comprising a plurality of tubular handle members and a plurality of handle connection members hingedly mountable to at least one of the plurality of lids, a pair of said handle connection members adapted to receive one of the tubular handle members therebetween.

22. The interchangeable and nestable storage system of claim 21, wherein the plurality of tubular handle members includes tubular handle members selected from a group of tubular handle members of a relatively short length and tubular handle members of a relatively long length.
